(19) United States
(12) Patent Application Publication
(10) Pub. No.: US 2017/0108129 A1
(43) Pub. Date: Apr. 20, 2017

(54) Valve Assembly

(71) Applicant: FESTO AG & Co. KG, Esslingen (DE)

(72) Inventors: Jakob Brenner, Esslingen (DE); Andreas Dickhoff, Kirchheim unter Teck (DE)

(73) Assignee: Festo AG & Co. KG, Esslingen (DE)

(21) Appl. No.: 15/122,826

(22) PCT Filed: Mar. 6, 2014
(86) PCT No.: PCT/EP2014/000566

§ 371 Date: Aug. 31, 2016

(51) Int. Cl. F16K 11/20

(52) U.S. Cl. CPC F16K 11/20

(57) ABSTRACT

A valve assembly including at least one valve control group, which has two valve units. Each valve unit contains a valve tappet, which is arranged in a valve chamber and which passes through an overflow opening framed by a valve seat and has a shut-off segment facing the valve seat. In addition, each valve tappet has a first closure segment and a second closure segment, which each close one of two valve chamber segments in a sealed manner. The diameters of the two closure segments of each valve tappet are equal among each other and also equal to or slightly less than the diameter of the overflow opening.

The invention relates to a valve assembly, with at least one valve control group that contains two first and second valve units in fluid communication with each other, which respectively have a longitudinal valve chamber bounded peripherally by a wall body and a valve tappet arranged in an axially displaceable manner in the valve chamber, wherein an axially oriented valve seat that is stationary with respect to the wall body is arranged in each valve chamber and surrounds an overflow opening that connects a first valve chamber section lying on the side of the valve seat to a second valve chamber section lying on the opposite side, wherein a shut-off section of the valve tappet lies opposite the valve seat in the first valve chamber section and in the context of an axial control movement of the valve tappet is moveable between a closure position abutting the valve seat and thereby closing the overflow opening and at least one open position lifted from the valve seat and thereby allowing a fluid overflow between the two valve chamber sections, wherein the first valve chamber section of the first valve unit and the second valve chamber section of the second valve unit are in constant fluid communication with one another and with a working opening that can be connected to a consumer, and wherein the second valve chamber section of the first valve unit is in communication with a pressure release opening leading to a drop in pressure and the first valve chamber section of the second valve unit communicates with a feed opening that can be connected to a pressure source.

A valve assembly of this type known from DE 203 05 052 U1 contains two valve control groups, which respectively comprise two first and second valve units in fluid communication with one another, which are designed in the manner of seating valves. Each valve unit contains a valve chamber in which is arranged an electromagnetically moveable valve tappet, which has a shut-off section that lies opposite an axially oriented valve seat. The valve seat surrounds an overflow opening that connects two valve chamber sections to one another, wherein by appropriate positioning of the valve tappet and consequently of the shut-off section a shutting off or release of the overflow opening can optionally be effected. In each valve control group two valve chamber sections of the two valve units are connected to one another as well as to a working opening. Also, the respective other valve chamber section in one of the valve units is connected to a pressure source and in the other valve unit is connected to a pressure sink in the form of the atmosphere. Each valve unit forms a 2/2-way valve, wherein by mutually adapted control of the valve units by means of a control device numerous multipath functions and switching functions can be achieved.

With the aforementioned valve assembly each shut-off section is tensioned by spring means in a closure position that closes the overflow opening. So that that also high operating pressures can be controlled, correspondingly high spring forces are necessary, which however also have to be overcome by the electromagnetic drive means if the valve assembly is adjusted to control only low operating pressures. Therefore the valve assembly can be economically operated only in certain narrow ranges of the operating pressure. A use in combination with alternating operating pressures is therefore not recommended. Consequently, in order to ensure an economic operation differently designed valve assemblies must be provided for different operating pressures. This involves increased production and storage costs.

From DE 102 08 390 A1 a multi-way valve is known, which is composed of at least four 2/2-way valves connected in series, which can be variably controlled so that numerous valve functions can be freely configured.

From EP 1 207 329 B1 a piezo valve is known, which comprises a bending transducer unit consisting of two bending transducers. Each bending transducer can control a fluid flow by cooperation with a valve seat associated with it. In this way different valve functions can be realised with one and the same piezo valve.

The object of the invention is to propose measures that enable an economic operation of the valve assembly also with different operating pressures.

To achieve this object it is envisaged in conjunction with the features mentioned in the introduction that each valve tappet passes through the overflow opening associated with it and comprises a first closure section tightly closing the first valve chamber section on the side axially opposite the overflow opening, and also a second closure section tightly closing the second valve chamber section on the side axially opposite the overflow opening, wherein the diameters (D1, D2) of the two closure sections of each valve tappet have the same size in relation to each other and are also of the same size or slightly smaller than the diameter (D3) of the overflow opening.

In this way a valve assembly is provided in which at least one valve control group is capable of selectively connecting a working opening that can be connected or is connected to a consumer, to a pressure source or to a pressure sink, in order either to supply the consumer with pressure medium or to relieve the pressure. A typical field of application is therefore the control of a fluid-actuated operating cylinder functioning as a consumer. A particular advantage of the valve assembly is that the actuating forces required to actuate the valve units do not depend or depend only insignificantly on the magnitude of the operating pressure to be controlled, which is attributed to the closure sections of the valve tappet disposed axially on both sides of the shut-off section, whose diameters closing the respectively associated valve chamber section are on the one hand the same size as one another and on the other hand also the same size as the diameter of the overflow opening that can be controlled by the shut-off section or are preferably somewhat smaller than the diameter of this overflow opening. In this way at least a compensation, which can also be termed pressure compensation, that is as large as possible of the pressure forces acting on the valve tappet in the axial direction is achieved, so that the actuating forces required to produce the control movement are not or are not noticeably influenced by the magnitude of the operating pressure, which enables an economic operation of the valve assembly also in conjunction with different operating pressures. An arrangement is preferred in which the diameters of the two closure sections is very slightly smaller than the diameter of the overflow opening, which in conjunction with the chosen arrangement of the valve chamber sections means that the valve tappets in the closure position are subjected to a slight pressure force acting in the closure direction. The magnitude of this resultant closure force depends on the pressure, so that the greater it becomes the greater the fluid pressure acting in the first valve chamber section. In this way a reliable shut-off of the overflow opening is ensured also with high fluid pressures. Nevertheless the actuating forces required to actuate the valve tappets are overall relatively slight, since the diameter of the overflow opening is only slightly larger than the diameter of the two closure sections.

The valve assembly also has the advantage that the overflow openings of the two valve units are subjected to fluid flow from the side of the first valve chamber section housing the shut-off section. As has been shown, in this connection the fluid flow helps to keep open the overflow opening. No noticeable flow forces are produced that then attempt to move the shut-off section to the closure position. This simplifies the control of the valve units and in particular favours a regulated mode of operation in combination with a proportional application.

Advantageous modifications of the invention follow from the sub-claims.

Conveniently the shut-off section of each valve tappet is formed as a valve disc, which is arranged axially spaced from the first closure section of the valve tappet closing the first valve chamber section. Thus, the pressure medium present in the first valve chamber section in the region lying between the shut-off section and the first closure section acts in the closing direction on the valve disc and in the opening direction on the first closure section.

The closure sections of each valve tappet are advantageously formed as closure pistons abutting in a sealing and sliding displaceable manner the internal circumferential surface of the wall body. Each closure piston advantageously has an annular seal forming the tight contact with the inner circumferential surface of the wall body. Such a construction has production and cost advantages compared to a static seal produced by membrane elements, which however in principle is also realisable. In the regions respectively cooperating with a closure piston the valve chamber has equally large diameters, wherein these diameters are just as large or preferably slightly larger compared to the diameter of the overflow opening.

Each valve unit expediently contains spring means that tension the valve tappet in the direction of the closing position. By means of the spring means the valve tappet in the non-actuated state is held in the closing position, which defines the normal position of the valve tappet. In this way it is ensured that the valve tappets in the non-actuated state and in particular also in the completely pressure-free state of the valve units adopt a defined normal position.

The valve assembly is conveniently equipped with an electrically actuable control device, by means of which the valve tappets can be charged with motive power in a controlled manner, in order to bring about their control movements and position them in the respectively desired switching position.

The valve units can be of directly electrically actuable construction, wherein the control unit is able to subject the valve tappets to electromagnetically or electrodynamically generated actuating forces and thereby position them appropriately. However, at the present time an arrangement of the valve assembly is preferred in which the valve tappets are actuated by means of fluid force. In this connection the control device is preferably designed as an electro-fluidic control device, which contains an electrically actuable pilot valve device that is able on the basis of electrical control signals transmitted to it to effect a fluid impact on the valve tappets to produce the controlled movement of the valve tappets. In this case the driving force necessary for the actuation of the valve tappets is applied to the latter by a drive fluid.

Preferably the control device is a proportional control device, which enables each valve tappet to be positioned steplessly, wherein each valve tappet can, apart from the closing position, also be positioned in several open positions raised differently far from the valve seat so that differently large flow cross-sections can be made available to the fluid to be controlled, which in particular also allows variations in the flow rate.

The control device expediently contains for each valve unit a position measuring system that records the instantaneous switching position of the valve tappet. The control device can utilise its signals in particular when regulating the position of the relevant valve tappet.

The valve assembly expediently contains a valve housing accommodating the valve tappet, on which is fitted a control housing accommodating the control device. The wall bodies defining the valve chambers are expediently designed as sleeve bodies inserted into the valve housing, but can also be formed directly by the valve housing itself.

If the valve units are of a construction that can be actuated by fluid force, it is advantageous if each valve tappet has a drive piston that can be charged in a controlled manner with a drive fluid, which in particular enables a fluid impact to open the valve tappet. The drive piston is expediently formed as a structural unit with one of the closure sections, in particular with the second closure section closing the second valve chamber section.

A particularly inexpensive construction of the valve assembly is possible if the two valve units of the valve control group are formed identically to one another. Compact dimensions can be achieved if the valve units are arranged with parallel longitudinal axes next to one another and thus at the same height in the axial direction of these longitudinal axes. It is considered particularly advantageous if the valve units are aligned so that their valve seats point in the same axial direction. This promotes an actuation of the valve tappets belonging to the same valve control group from the same axial side of the valve assembly.

It is advantageous if the two valve tappets of each valve control group are arranged in a common valve housing, which is conveniently formed in one piece. A connecting channel is formed in this valve housing, which connects the first valve chamber section of the first valve unit to the second valve chamber section of the second valve unit and from which also branches a working channel that leads to the working opening, which is arranged outside on the valve housing. The connecting channel is conveniently S-shaped, wherein the working channel expediently branches off in a middle section from the connecting channel.

Expediently the wall body of each valve unit is sleeve-shaped and formed separately from the valve housing, and is inserted into the valve housing. Particularly convenient is a construction in which the two valve units are formed as cartridges and are inserted respectively axially into a seating bore of the valve housing, wherein each valve unit has a sleeve-shaped wall body into which the respective valve tappet can be captively inserted by axial positive engagement. The valve units can thus be inserted as a preassembled module into the associated seating bore of the valve housing when assembling the valve assembly.

The valve assembly can have only a single valve control group, or also several, in particular more than two, valve control groups. Each of these valve control groups is formed in the way explained above. It is advantageous in this connection if the first valve chamber sections of the second valve units of the several valve control groups communicate jointly with a feed opening that can be connected to a pressure source, so that they can be supplied jointly via a single feed opening with the pressure medium to be controlled. Expediently a common pressure release of all valve units also takes place, for which purpose the second valve chamber sections of the first valve units of the present valve control groups communicate jointly with a pressure release opening, which in turn leads to a pressure sink, in particular to the atmosphere.

The valve assembly can be used in particular for controlling compressed air. However, it is also suitable for controlling other gaseous media and also for controlling liquid media. In addition the valve assembly is also suitable for controlling a vacuum.

The invention is described in more detail hereinafter with the aid of the accompanying drawings, in which:

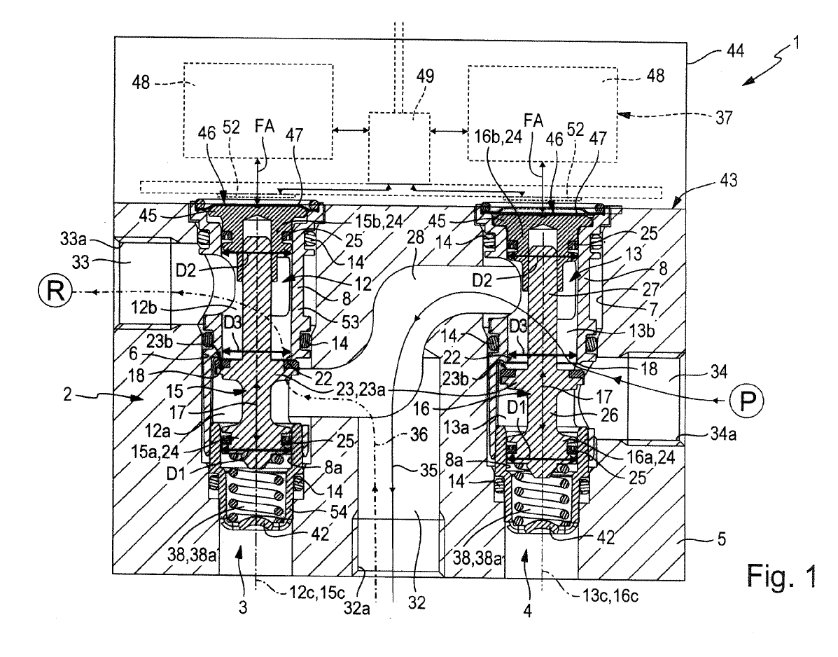

FIG. 1 shows a longitudinal section through a preferred embodiment of the valve assembly according to the invention, in which a preferred existing control device is illustrated only schematically,

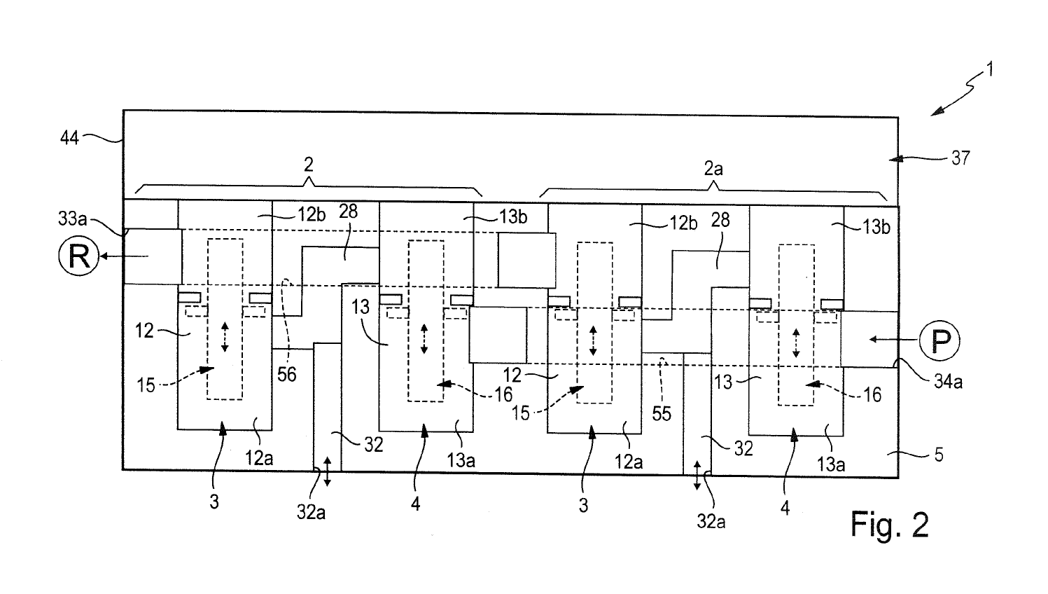

FIG. 2 shows a schematic representation of a further advantageous embodiment of the valve assembly, which is provided with two valve control groups in contrast to the valve assembly of FIG. 1, which is provided with only one valve control group.

The valve assembly denoted overall by the reference numeral 1 is provided with at least one valve control group 2, which has two valve units in fluid communication with one another, which are identified as first valve unit 3 and second valve unit 4. Whereas the exemplary embodiment of FIG. 1 contains only a single valve control group 2, the exemplary embodiment illustrated in FIG. 2 is additionally provided with a further, second valve control group 2a, whose construction however is the same as that of the valve control group 2. The following description will concentrate first of all on the construction of the valve assembly 1 illustrated in FIG. 1.

The valve assembly 1 contains a valve housing 5, which is preferably formed in one piece and in which the two valve units 3, 4 are accommodated. The valve housing 5 contains a first seating bore 6, which accommodates the first valve unit 3, and furthermore contains a second seating bore 7, which accommodates the second valve unit 4.

Each valve unit 3, 4 has a longitudinal wall body 8, which in the exemplary embodiment is a separate body with respect to the valve housing 5 and which in this case is formed in particular as a sleeve. The wall body 8 of the first valve unit 3 peripherally borders a longitudinal first valve chamber 12, while the wall body 8 of the second valve unit 4 peripherally borders a longitudinal second valve chamber 13. The first valve chamber 12 has a longitudinal axis 12c, and the second valve chamber 13 has a longitudinal axis 13c.

A plurality of sealing rings 14 axially spaced apart from one another are arranged around each wall body 8, which form a structural seal between the outer circumferential surface of the wall body 8 and the inner circumferential surface of the associated seating bore 6, 7.

The valve unit 3 contains a first valve tappet 15 arranged in the first valve chamber 12, whose longitudinal axis 15c coincides with the longitudinal axis 12c of the first valve chamber 12. The second valve unit 4 contains a second valve tappet 16 arranged in the second vale chamber 13, which like the first valve tappet 15 has a longitudinal contour and whose longitudinal axis 16 coincides with the longitudinal axis 13 of the first valve chamber 13.

Each valve tappet 15, 16 can move lineally backwards and forwards in the associated valve chamber 12, 13 in its longitudinal direction with the execution of a control movement 17 indicated by a double arrow.

An annular valve seat 18 co-axial with respect to the longitudinal axis 12a, 13a is located in each of the two valve chambers 12, 13, and is aligned axially, i.e. in the axial direction of the longitudinal axis 12a, 13a. The valve seat 18 surrounds an overflow opening 22, which in the case of the first valve unit 3 connects a first valve chamber section 12a to a second valve chamber section 12b, and which in the case of the second valve unit 4 connects a first valve chamber section 13a to a second valve chamber section 13b. The overflow opening 22 in both valve units 3, 4 thus lies axially between the respective first valve chamber section 12a, 13a and in the second valve chamber section 12b, 13b.

In each valve unit 3, 4 the first valve chamber section valve chamber section 12a, 13a lies on the side of the valve seat 18. In other words, the valve seat 18 faces towards the respective first valve chamber section 12a, 13a.

Each valve tappet 15, 16 extends axially through the associated overflow opening 22 and consequently has a first longitudinal section extending in the first valve chamber section 12a, 13a, and a second longitudinal section extending in the second valve chamber section 12b, 13b.

The first longitudinal section of each valve tappet 15, 16 extending in the valve chamber section 12a, 13a has a shut-off section 23 lying axially opposite the valve seat 18. This is preferably in the shape of a valve disc 23a with annular front surfaces opposite one another. On the side facing towards the valve seat 18 the shut-off section 23 has an annular sealing surface 23b, which is preferably formed from a material having rubber-elastic properties. The valve tappet 15, 16 can adopt a closure position in which it abuts with its sealing surface 23b against the valve seat 18 to form a seal, so that the overflow opening 22 is shut off and the two valve chamber sections 12a, 12b; 13a, 13b are separated in a fluid-tight manner from one another. Such a closure position is illustrated in FIG. 1, with the first valve unit 3 depicted on the left hand side.

The valve tappet 15, 16 can also be positioned in at least one open position, in which the shut-off section 23 is raised from the valve seat 18, so that it is axially spaced from the valve seat 18. In this case the overflow opening 22 is open and a flow connection between the two valve chamber sections 12a, 12b; 13a, 13b exists through the overflow opening 22. In FIG. 1 the valve tappet 16 of the second valve unit 4 depicted on the right adopts an open position.

The valve tappet 15, 16 can in the context of the control movement 17 be positioned as desired in the closure position or in the desired open position. Preferably the valve tappet 15, 16 can be positioned in different open positions, and specifically preferably continuously, which are characterised by different axial distances between the shut-off section 23 and the valve seat 18, so that a differently large free flow cross-section is formed. In this way the flow rate of the pressure medium can be influenced.

The valve seat 18 is formed fixed with respect to the wall body 8. Preferably it is a one-piece constituent of this wall body 8.

Each valve tappet 15, 16 has on its first longitudinal section associated with the first valve chamber section 12a, 13a a first closure section 15a, 16a, which tightly seals the first valve chamber section 12a, 13a at the side axially opposite the overflow opening 22. On its second longitudinal section associated with the second valve chamber section 12b, 13b each valve tappet 15, 16 has a second closure section 15b, 16b that also tightly closes the second valve chamber section 12b, 13b on the side axially opposite the overflow opening 22. This closure function does not adversely affect the relative mobility of the valve tappet 15, 16 with respect to the wall body 8.

Preferably each of the closure section 15a, 15b; 16a, 16b is formed in the manner of a closure piston 24, which rests in a sliding displaceable manner on the inner circumferential surface 8a of the wall body 8 to form a seal. Each closure piston 24 expediently comprises a sealing ring 25 co-axial to the longitudinal axis 15c, 16c, which rests in a sliding displaceable manner on the inner circumferential surface 8a with the formation of a seal. Preferably the sealing ring is a lip-shaped sealing ring, which has a sealing lip resting against the internal circumferential surface 8a, whose free end faces towards the overflow opening 22.

The two closure sections 15a, 15b; 16a, 16b of a respective valve tappet 15, 16 are arranged spaced from the associated shut-off section 23. A first intermediate section 26 of the valve tappet 15, 16 extends between the first closure section 15a, 16a and the shut-off section 23. A second intermediate section 27 of the valve tappet 15, 16 extends between the second closure section 15b, 16b and the shut-off section 23. The diameters of the intermediate section 26, 27 are smaller than the diameter D3 of the overflow opening 22. Also, these diameters are expediently also smaller than the diameter D1 of the first closure section 15a, 16a and smaller than the diameter D2 of the second closure section 15b, 16b.

A connecting channel 28 preferably formed in the valve housing 5 produces independently of the switching positions of the two valve tappets 15, 16 a permanent fluid connection between the first valve chamber section 12a of the first valve unit 3 and the second valve chamber section 13b of the second valve unit 4. A working channel 32 branching from this connecting channel 28, which is preferably also formed in the valve housing 5, leads to a working opening 32a arranged outside on the valve housing 5, to which can be connected a consumer, for example a fluid-actuated drive, to be controlled by means of the valve assembly 1. For this purpose suitable connecting means are associated with the working opening 32a, for example a connection thread or also a push-in fitting.

Consequently the first valve chamber section 12a of the first valve unit 3 and the second valve chamber section 13b of the second valve unit 4 are in constant communication with one another and at the same time also with the working opening 32a.

The second valve chamber section 12b on the first valve chamber 12 communicates independently of the switching position of the first valve tappet 15 with a pressure release opening 33a, which is connected to a pressure sink R, in particular the atmosphere. The pressure release opening 33a is conveniently arranged outside on the valve housing 5 and defines the outer end of a pressure release channel 33, which is permanently connected to the second valve chamber section 12b of the first valve chamber 12.

A feed opening 34a connected or that can be connected to a pressure source P communicates independently of the switching position of the second valve tappet 16 with the first valve chamber section 13a of the second valve chamber 13. The feed opening 34a is conveniently arranged on an external surface of the valve housing 5 and forms the outer end of a feed channel 34, which is conveniently formed in the valve housing 5 and at the other end is in permanent fluid communication with the first valve chamber section 13a of the second valve chamber 13.

The pressure source P has a fluid pressure medium used as working fluid, which in particular is compressed air.

The connecting channel 28, the pressure release channel 33 and the feed channel 34 conveniently in each case terminate peripherally, i.e. at the radial outer circumference in the associated valve chamber section of the valve chamber 12 or 13. In this way the aforementioned fluid channels pass through the wall body 8.

The two valve units 3, 4 can be operated in a mutually adapted manner in order to supply the aforementioned working medium to the consumer connected to the working medium 32 or to remove the working medium from the consumer.

In this connection the valve assembly 1 can adopt inter alia the first operating state illustrated in FIG. 1, in which the first valve tappet 15 adopts the closure position and the second valve tappet 16 adopts an open position. In this way working fluid flows according to the continuous flow line 35 from the pressure source P through the feed channel 34 to the first valve chamber section 13a, the open overflow opening 22, the second valve chamber section 13b, the connecting channel 28 and the working channel 32 to the working opening 32a and from there to the consumer. The passage of fluid through the overflow opening 22 of the first valve unit 3 is thereby closed off.

In a second possible operating position of the valve assembly 1 the first valve tappet 15 is in an open position and the second valve tappet 16 adopts the closure position. In this case the pressure source P is separated by the second valve unit 4 from the connecting channel 28, while at the same time the working opening 32 is connected via the working channel 32, the connecting channel 28, the first valve chamber section 12a, the overflow opening 22 of the first valve unit 3, the second valve chamber section 12b and the pressure release channel 33, to the pressure release opening 33a. The latter leads to a pressure release flow 36, indicated by a chain-dotted line, of the working fluid coming from the consumer to the pressure sensor R.

As already mentioned, in each of the two operating positions the open position of the opened valve tappet can be varied in order to influence the flow rate.

Preferably a third operating position of the valve assembly 1 is also possible, in which both valve tappets 15, 16 adopt the closure position, so that the working opening 32a is separated in a fluid-type manner from the feed opening 34a as well as from the pressure release opening 33a.

In order to adopt the respectively desired switching position, each valve tappet 15, 16 can be subjected to a variable drive force FA, which is symbolised by the double arrow in FIG. 1. The valve assembly 1 is conveniently equipped with an electrically actuable control device 37 that is able to control the action of the drive force FA on the valve tappets 15, 16 in order to produce in this way the desired controlled movement 17 and to position each valve tappet 15, 16 in the desired switching position.

In order to maintain a defined normal position, it is convenient if each valve unit 3, 4 is provided with its own spring means 38, which permanently force the associated valve tappets 15, 16 in the direction of the closure position, so that the valve slide 15, 16 adopts the closure position when no driving force FA is acting on it. The effective direction of the driving force FA is opposite to the spring force of the spring means 38.

Conveniently the spring means 38 act between the wall body 8 and the respectively associated valve tappet 15, 16. As an example, the spring means 38 of both valve units 3, 4 are formed by a compression spring 38a, which is arranged axially after the valve tappet 15, 16, and specifically after the second closure section 15a, 16a. The compression spring 38a is supported axially on the one hand on the first closure section 15a, 16a and on the other hand on a supporting wall section 42 of the wall body 8 spaced therefrom.

A specific structural feature of the valve assembly 1 is that in both valve units 3, 4 the diameter D1 of the first closure section 15a, 16a of the valve tappet 15, 16 is as large as the diameter D2 of the second closure section 15b, 16b of the same valve tappet 15, 16. These diameters correspond to the internal diameters of those longitudinal sections of the valve chambers 12, 13 with which the closure sections 15a, 15b, 16a 16b cooperate for the axial closure of the valve chambers 12, 13, with the formation of a seal. In addition the diameter D3 of the overflow opening 22, i.e. the diameter of the valve seat 18, is either as large as that of the aforementioned diameters D1, D2 or however is slightly larger than each of these two diameters D1, D2. This has the result that each valve tappet 15, 16 is on the one hand fully compensated as regards compression force in each open position, and on the other hand is either completely compensated as regards compression forces in the closure position, or experiences a slight resulting closure force resulting from the pressure prevailing in the closure position in the first valve chamber section 12a, 13a in combination with the difference in area resulting from the difference in diameter.

A preferred construction envisages the aforementioned slight diameter difference between the diameter D3 of the overflow opening and the somewhat smaller diameters D1, D2 of the two closure sections 15a, 15b; 16a, 16b, since here the shut-off section 32 in the closure position is forced increasingly more strongly against the valve seat 18 the greater the fluid pressure acting in the first valve chamber section 12a, 13a. In this way a reliable sealing effect is guaranteed in the closure position of the valve tappets 15, 16 also under varying pressure conditions, without the need for any structural alterations.

The channel switching outlined further above has the advantageous effect that the feed flow 35 as well as the pressure release flow 36 pass through the associated open overflow opening 22 from the side of the first valve chamber section 12a, 13a, i.e. from the side of the valve seat 18. As has been shown, in this flow direction the fluid flow does not act forcibly or at least not in a relevant manner on the shut-off section 23, which facilitates the control or indeed regulation of the drive force FA.

The two valve units 3, 4 belonging to the same valve control group 2 are advantageously arranged next to one another with their longitudinal axis parallel to one another, and more especially so that their valve seats 18 point in the same axial direction. This has the result that the first closure sections 15a, 15b point in the same direction and that the second closure sections 15b, 16b also point in the same direction. If then the valve units 3, 4 are placed at the same height in the axial direction of the longitudinal axis 12c, 13c, the first valve chamber sections 12a, 13a as well as the second valve chamber sections 12b, 13b lie at the same axial height. It is advantageous particularly in this connection if the two valve units 3, 4 are formed identically to one another.

In this way the two valve units 3, 4 of the valve control group 2 can be integrated in a space-saving manner in a very confined space in the valve housing 5.

The connecting channel 8 has in this connection preferably an at least substantially S-shaped path. By means of this path the axial misalignment between the first valve chamber section 12a of the first valve unit 3 and the second valve chamber section 13b of the second valve unit 4, which are joined to one another by the connecting channel 28, can be bridged in a manner particularly favourable to flow.

The working channel 32 preferably branches from this connecting channel 28 in the longitudinal central region of the connecting channel 28.

The valve housing 5 conveniently has an installation surface 43, to which the two seating bores 6, 7 are open. The valve units 3, 4 are aligned so that the second closure sections 15b, 16b, of the valve tappets 15, 16 are associated with this installation surface 43. The already mentioned control device 37 is conveniently arranged on the installation surface 43, which consequently can optimally cooperate with the two valve units 3, 4.

Preferably the control device 37 is installed in a housing denoted as control housing 44, which is formed on the valve housing 5 in the region of the installation surface 43.

The valve units 3, 4 are preferably of the type that can be actuated by means of fluid force. This is also the case with the exemplary embodiment. In this connection each valve tappet 15, 16 has a drive piston 45, which comprises a drive surface 46 pointing in the opposite axial direction to the valve seat 18, which drive surface can be subjected in a controlled manner to a drive fluid providing the drive force FA.

The drive surface 46 is formed for the direct or indirect fluid impact by the drive fluid. The exemplary embodiment includes an arrangement for the indirect fluid impact, which is implemented in that an elastically deformable membrane element 47 is installed in front of the drive surface 46 of the drive piston 45, which element is fixed to the wall body 8 to form a static seal and can be impacted by the drive fluid so that it is forced against the drive surface 46 of the drive piston 45 and can drive the latter forwards.

It is considered convenient if in each valve tappet 15, 16 the drive piston 45 is formed as a structural unit with the second closure sections 12b, 13b.

The control device 37 contains by way of example an electrically actuable pilot valve device 48, which can be composed of several components and which can be electrically controlled by an electronic control unit 49, which preferably is at least in part a constituent of the control device 37.

The pilot valve device 48 is in fluid connection with the two valve units 3, 4 and is able on the basis of electrical control signals to subject the drive piston 45 to the action of the aforementioned drive fluid. The electrical control signals are received from the control unit 49, which when generating the electrical control signals can access feedback signals, which reflect the current operating state of the valve units 3, 4 and/or of the consumer connected to the working opening 32a. The control unit 49 integrated into the control device 37 is also preferably designed so that it can communicate with an external electronic control unit, not illustrated.

Preferably the control device 37, which in the exemplary embodiment is an electro-fluid control device, is designed in such a way that it can process the instantaneous switching position of the valve tappets 15, 16. For this purpose it is advantageous if a position measuring system 52 connected to the control unit 49 is associated with each valve tappet 15, 16, which is designed to record the instantaneous switching position of the relevant valve tappet 15, 16.

On the basis of the measurement values of the position sensing system 52 and also taking into account external feedback data, in particular position data of a consumer to be controlled, the controller unit 49 is able to control the pre-adjustment valve device 49 so that the valve tappets 15, 16 of both valve units 3, 4 are positioned as required.

The control device 37 is preferably a proportional control device, which enables a continuous movement and positioning of the valve tappets 15, 16 so that in particular also different open states of both valve tappets 15, 16 can be adjusted.

The valve units 3, 4 are preferably designed as cartridges and are inserted respectively as a structural unit into the associated seating bore 6, 7 of the valve housing 5. In this connection each valve unit 3, 4 is already before the insertion into the seating bore 6, 7 a coherent unit, which contains the sleeve-shaped wall body 8 and the valve tappet 15, 16 installed operationally ready in this wall body. In this connection the valve tappet 15, 16 is held captive by axial positive engagement with the wall body 8 in the valve chamber 12, 13 defined by the wall body 8.

The axially acting positive engagement connection between the aforementioned components 8, 15, 16 of the valve unit 3, 4 has the result in the exemplary embodiment that the valve tappet 15, 16 is supported with its shut-off section 23 in one direction on the associated valve seat 18 and is held in the opposite direction by the spring means 38.

So that also cartridge-shaped valve units 3, 4 that can be termed valve cartridges can be assembled easily, it is advantageous if the wall body 8 has a multipart structure. In the exemplary embodiment the wall body has a sleeve section 53 and a cap section 54 that are axially plugged into one another and are pressed together and/or bonded and/or welded. The cap section 54 contains the supporting wall section 42. Before the sleeve section 53 and the cap section 54 are joined together the valve tappet 15, 16 and the spring means 38 are inserted.

Also the valve tappet 15, 16 is advantageously formed in several parts and in particular is composed of two axially joined valve tappet sections, which in particular are joined to one another by a press fitting and/or weld joint and/or adhesive joint.

In a non-illustrated exemplary embodiment the wall body of the valve units 3, 4 is formed directly from the valve housing 5, wherein the seating bores 6, 7 respectively directly define a valve chamber 12, 13 accommodating a valve tappet 15, 16.

The valve assembly illustrated in FIG. 2 contains apart from a valve control group 2 of the afore-described construction, also a further valve control group 2a, whose construction corresponds to that of the described valve control group 2. Such a valve assembly 1 contains two working openings 32a, which can be supplied with working fluid or undergo pressure release independently of one another by means of the respectively associated valve control group 2, 2a, and which are therefore suitable for connecting a consumer in the form of a double-acting working cylinder. It is understood that the control device 37 is in this case formed so that it can control both valve control groups 2, 2a in the manner outlined above.

The two valve control groups 2 conveniently have a common valve housing 5. This valve housing 5 can in particular have four seating bores, into which respectively a cartridge-shaped valve unit 3, 4 is inserted.

With a valve assembly 1 that is provided with a multiplicity of valve control groups 2, it is convenient to provide outside on the valve housing in addition only a single feed opening 34a, which however communicates with the first valve chamber section of each second valve unit 4. It is also advantageous to connect the second valve chamber sections 15b of the first valve units 3 to a common pressure release opening 33a. For the corresponding internal fluid connection in the valve housing 5, a collecting feed channel 55 and a collecting-release channel 56 are provided for this purpose.

For all exemplary embodiments of the valve assembly 1, the pressure release opening 33a and the feed opening 34a are by way of variation from the illustrations conveniently arranged on one and the same outer surface of the valve housing 5, so that it is possible to install the valve assembly 1 with this outer surface beforehand on a distributor body. There is also then the advantageous possibility of installing several of the valve assemblies 1 in a battery-like arrangement behind one another on such a distributor body.

1. A valve assembly, comprising at least one valve control group that contains two first and second valve units in fluid connection with one another, which respectively comprise a longitudinal valve chamber peripherally bounded by a wall body and a valve tappet arranged in an axially displaceable manner in the valve chamber, wherein an axially oriented valve seat stationary with respect to the wall body is arranged in each valve chamber and surrounds an overflow opening that connects a first valve chamber section lying on the side of the valve seat with a second valve chamber section lying on the opposite side, wherein a shut-off section of the valve tappet lies opposite the valve seat in the first valve chamber section, which shut-off section in the context of an axial control movement of the valve tappet is moveable between a closure position abutting the valve seat and thereby closing the overflow opening and at least one open position raised from the valve seat and thereby allowing a fluid overflow between the two valve chamber sections, wherein the first valve chamber section of the first valve unit and the second valve chamber section of the second valve unit are in constant fluid communication with one another and with a working opening that is connectable to a consumer, and wherein the second valve chamber section of the first valve unit communicates with a pressure release opening leading to a pressure sink and the first valve chamber section of the second valve unit communicates with a feed opening that is connectable to a pressure source and wherein each valve tappet passes through the overflow opening associated with it and comprises a first closure section tightly closing the first valve chamber section on the side axially opposite the overflow opening and also comprises a second closure section tightly closing the second valve chamber section on the side axially opposite the overflow opening, wherein the diameters of the two closure sections of each valve tappet are of the same size in relation to each other and are also of the same size or slightly smaller than the diameter of the overflow opening.

2. The valve assembly according to claim 1, wherein the shut-off section of each valve tappet is formed as a valve disc, which is arranged in the first valve chamber section axially spaced from the first closure section of the valve tappet.

3. The valve assembly according to claim 1, wherein the closure sections of each valve tappet are formed as closure pistons lying in a sealing and sliding displaceable manner on the internal circumferential surface of the wall body.

4. The valve assembly according to claim 1, wherein spring means of the valve unit are associated with each valve tappet, which pretension the valve tappet in the direction to the closure position.

5. The valve assembly according to claim 1, wherein the valve assembly contains an electrically actuable control device which is designed to act on the valve tappets in a controlled manner with a driving force for the purpose of producing their control movement and for pre-setting their respective switching position.

6. The valve assembly according to claim 5, wherein the valve units are of a construction that is actuable by fluid force, wherein the control device is an electro-fluidic control device that contains an electrically actuable pilot valve device that is designed for acting upon the valve tappets in a controlled manner with a drive fluid providing the driving force on the basis of electrical control signals supplied by an electronic control unit.

7. The valve assembly according to claim 5, wherein the control device is a proportional control device, through which the valve tappets can be positioned continuously selectively in the closure position as well as in several open positions releasing different flow cross-sections of the overflow opening.

8. The valve assembly according to claim 5, wherein the control device for each valve unit contains a position measuring system detecting the instantaneous switching position of the valve tappet.

9. The valve assembly according to claim 5, further comprising a valve housing accommodating the valve tappets and on which is mounted a control housing accommodating the control device.

10. The valve assembly according to claim 1, wherein the valve units are of a construction that can be actuated by fluid force.

11. The valve assembly according to claim 10, wherein each valve tappet comprises a drive piston that can be subjected in a controlled manner by a drive fluid.

12. The valve assembly according to claim 1, wherein the two valve units of the valve control group are arranged next to one another with their longitudinal axes parallel to one another and thereby at the same height in the axial direction of these longitudinal axes, wherein they are aligned so that their valve seats point in the same axial direction.

13. The valve assembly according to claim 12, wherein the two valve tappets of each valve control group are arranged in a joint valve housing, in which is formed a connecting channel connecting the first valve chamber section of the first valve unit to the second valve chamber section of the second valve unit, from which connecting channel branches a working channel leading to the working opening and which connecting channel conveniently has at least substantially a S-shaped course.

14. The valve assembly according to claim 13, wherein the two valve units are formed in the shape of cartridges and are respectively axially inserted into a seating bore of the valve housing, wherein each valve unit has a sleeve-shaped wall body in which the associated valve tappet is captively fixed.

15. The valve assembly according to claim 1, wherein the valve assembly contains two valve control groups, wherein the first valve chamber sections of the second valve units of the two valve control groups communicate jointly with a feed opening that is connectable to a pressure source.

16. A valve assembly according to claim 11, wherein the drive piston is formed in a structural unit with one of the closure sections.

17. A valve assembly according to claim 12, wherein the two valve units of the valve control group are formed identical to one another.

18. A valve assembly according to claim 13, wherein the joint valve housing is made in one piece.
